(19) United States
(12) Patent Application Publication
(10) Pub. No.: US 2005/0208182 A1
(43) Pub. Date: Sep. 22, 2005

(54) Slow cooker compositions and methods of making and using same

(76) Inventors: Jon Chris Gilbert, Maple Grove, MN (US); Brian E. Glass, Maple Grove, MN (US); Eva Kaustinen, Minneapolis, MN (US); Philip E. Palkert, Eden Prairie, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/806,043

(22) Filed: Mar. 22, 2004

(51) Int. Cl. A23L 1/00

(52) U.S. Cl. 426/87

(57) ABSTRACT

Shelf stable meal kits for slow cooker applications, the meal kits including a dehydrated vegetable product characterized by having an exterior surface composed of a hardened, closed cell structure. The invention further provides shelf stable meal kits for slow cooker applications, the meal kits including a dehydrated vegetable product having a vitreous like material on 25% or more of the surface area of the vegetable product. Further provided are shelf stable meal kits for slow cooker applications that include a dehydrated vegetable product having a stabilizing amount of a stabilizer. Methods for rehydrating dehydrated vegetables, as well as methods for preparing meal kits for slow cooker applications are also provided.

### FIELD OF THE INVENTION

The invention relates to meal kits for slow cooker, or crockery cooker applications. More particularly, the invention relates to shelf stable meal kits that include dehydrated food products capable of reconstitution in slow cooker applications.

### BACKGROUND OF THE INVENTION

Commercially available meal kits typically include a plurality of pre-measured meal components packaged together for consumer use in preparation of a meal. Some meal kits include a plurality of pouches containing different meal components that are to be combined with, for example, water, milk, butter, margarine, salt, and/or other commonly available ingredients, with instructions for preparation of the meal included in or on the package. The steps required for preparation of the meal can include, for example, one or more steps involving mixing or otherwise combining various components, and one or more cooking steps.

Commercially available meal kits can include dehydrated food products. Dehydration of food products such as fruits, vegetables, and meats, is one of the oldest methods of preserving food. Generally speaking, dehydration is the application of heat under controlled conditions to remove the majority of the water normally present in a food by evaporation (or, in the case of freeze drying, by sublimation). The main purpose of dehydration is to extend the shelf life of foods by a reduction in the water activity, which inhibits microbial growth and enzyme activity.

Commercial production of dehydrated foods is a development of the twentieth century. During the last several decades, procedures have been developed in an attempt to produce dehydrated products that upon reconstitution resemble fresh food in taste, texture, and appearance. All products undergo changes during drying and storage that reduce their quality compared to the fresh material. The main changes include changes to texture of the food, as well as loss of flavor or aroma, color, and nutritional value. In general, as water is removed during dehydration, solutes move from the interior of the food piece to the surface. Evaporation of water causes concentration of these solutes at the surface. High air temperatures can cause complex chemical and physical changes to solutes at the surface, and the formation of a hard semi-impermeable skin of vitreous like material with a closed cell structure. This is termed “case hardening,” and it reduces the rate of dehydration to produce a food with a dry surface and a moist interior. In general, case hardening is seen as an undesirable occurrence during preparation of dehydrated food products, since the hard surface of the food product can adversely affect rehydration of the food piece. Thus, current dehydration methods aim to avoid case hardening of the food pieces.

Recently, cooking and eating habits have been influenced by a number of factors that reduce the time allocated for food preparation in households as well as in eating establishments. This in turn has created a desire for nutritious foods that can be prepared quickly and with minimal time expenditure. Food products that are “quick reconstituting” or “quick rehydrating” typically refer to dehydrated foods that are capable of rehydration to replace at least 90% of previously removed moisture in less than 60 minutes, typically less than 30 minutes. For example, dehydrated vegetables are primarily used as flavoring in soups, stocks, casseroles, and the like. Dehydrated vegetables used in instant soups (soups having a reconstitution time of less than about 5-20 minutes) have been small in size in order to permit preparation within the prescribed time period. Normally, the vegetable piece size is no larger than about 1/8 inch in cross-section, and in many cases, the dehydrated products have been reduced to a powder. Despite this smaller size, the dehydrated pieces can reconstitute incompletely and can be tough and chewy, resulting in unsatisfactory product.

While employment of smaller dehydrated vegetable pieces is useful in connection with conventional dehydrated food products for use in soups, casseroles, and the like, it would be advantageous from a consumer standpoint to provide dehydrated food products more reminiscent of homemade meals, and in particular, slow cooker meals that include larger food pieces. However, a variety of problems can arise when such larger food pieces are incorporated into a dehydrated food product (such as a dehydrated meal kit) intended for slow cooking.

A first problem relates to the nature of cooking with a slow cooker in general. Slow cooking, also referred to as “crock pot cooking” or “crockery cooking,” utilizes relatively low cooking temperatures (for example, typically less than 300° F. or less than 200° F.) for extended periods of time (for example, more than 4 hours). Such long cooking times can adversely affect the integrity of dehydrated food products.

Another problem relates to the texture of the food pieces. Water that is removed from a food piece during dehydration cannot be replaced in the same way when the food is rehydrated (put another way, rehydration is not the reverse of drying). Loss of cellular osmotic pressure, changes in cell membrane permeability, solute migration, crystallization of polysaccharides, and coagulation of cellular proteins can all contribute to texture changes, and each of these are irreversible. Heat reduces the degree of hydration of starch and the elasticity of cell walls, and coagulates proteins to reduce their water-holding capacity. During rehydration, the food product absorbs water more slowly. One common problem when rehydrating dehydrated food pieces is sloughing of the surface of the food piece, particularly if case hardening of the food piece occurred during preparation of the meal kit.

### SUMMARY OF THE INVENTION

The invention relates generally to the production of meal kits that include dehydrated food products, preferably meal kits that include dehydrated vegetables. More particularly, the invention is directed to compositions and methods for the preparation of meal kits that include dehydrated vegetable products that are capable of rehydration in a slow cooker to more closely resemble the taste, texture, size and appearance of fresh vegetables. In preferred embodiments, the dehydrated food products are particularly suitable for storage for extended periods of time without the need for refrigeration or freezing.

The inventive meal kits include components that exhibit reconstitution properties and characteristics that are not exhibited by dehydrated vegetable products currently available in the market. The dehydrated products of the invention are treated in such a way to allow reconstitution in slow cooker applications, which involve long cooking times (for example, 4 hours or more, 6 hours or more, 8 hours or more, or 10 hours or more) at lower temperatures (for example, less than 210° F., or less than 200° F., or in the range of 150° to 210° F.).

The compositions and methods of the invention are particularly applicable to slow cooker (also referred to as Crock-Pot™ or crockery cooker), applications. Generally, the slow cooker includes two temperature settings (low and high), and can include a crockery insert. The distinction between the “low” and “high” temperature settings relates to the amount of time it takes food product contained within the Crock-Pot™ to reach a particular temperature, which in turn is controlled by the power (wattage) delivered by the “low” or “high” setting. These values are typically printed on the bottom of the slow cooker, and the wattage is generally related to both the age and size of the slow cooker (for example, older/smaller slow cookers typically have lower wattage). More specifically, a low setting delivers approximately 75-140 Watts (W), and a high setting delivers approximately over 140 W. As a general matter, product temperature in a slow cooker will reach a temperature in the range of 130° to 140° F. in 4 hours on a low setting and in 2 hours on a high setting. The final product temperature range for both temperature settings is typically in the range of about 175 to about 210° F. Heating elements typically wrap around the sides of the cooker, which allows for the continuous slow cooking needed for such preparations as stews, and the like. Typically, thawed or partially precooked foods, such as raw or (if desired) browned meat are added to the slow cooker (in contrast, meats or vegetables in a frozen state are not suitable for adding to a slow cooker).

In use, ingredients such as vegetables, meat, seasonings, and water are added to a slow cooker, and the mixture is covered and cooked on a low setting for about 8 to 12 hours or on a high setting for about 4 to 6 hours. Cooking in a slow cooker is highly convenient because it allows a user to simply combine all ingredients into the cooker, turn the cooker on, and leave the cooker unattended until the user is ready to eat the food. Moreover, given the lower temperatures at which the food is cooked, as well as the arrangement of the heating elements, there is great latitude in cooking times (the user can stop the cooking process once the ingredients are suitably tender). Thus, one can simply add all ingredients to a slow cooker early in the day, for example, before going to work, and return to the home at the end of the day to a prepared dinner.

Generally, the meal kits include a dehydrated vegetable product. One or more features of the dehydrated vegetable products can be altered to provide desired reconstituted food products, that is, final cooked food products having a desired moisture content. This desired moisture content of the cooked food product can be characterized by replacement of at least 80%, or at least 85%, or at least 90%, or at least 95% of the previously removed moisture in 1 hour or more at an average temperature of 200° F. or less.

Thus, in some aspects, the invention provides meal kits for slow cooker applications, the meal kits comprising a dehydrated vegetable product having a vitreous like material content of at least 25% of the surface area of the dehydrated vegetable product, and instructions for preparation of a meal using the dehydrated vegetable product in a slow cooker. In some embodiments, when the meal kit comprises an assortment of more than one type of dehydrated vegetable product, at least one type of dehydrated vegetable product of the assortment can have a vitreous like material content of at least 25% of the surface area of the dehydrated vegetable product type.

In some aspects, the invention provides meal kits for slow cooker applications, the meal kits comprising a dehydrated vegetable product having a functional (stabilizing) amount of a stabilizer, and instructions for preparation of a meal using the dehydrated vegetable product in a slow cooker. In some embodiments, when the meal kit includes an assortment of more than one type of dehydrated vegetable product, one or more types of the dehydrated vegetable products of the assortment can include a functional amount of a stabilizer.

In still further aspects, the dehydrated vegetable products of the invention can be provided in larger sizes than heretofore was thought possible for products configured for rehydrating applications. Upon rehydration, the products reconstitute to a uniform degree, and the resultant product does not exhibit objectionable interiors (e.g., chewy) or exteriors (e.g., mushy surfaces that tend to slough during reconstitution), as is typically the case with conventionally dried products. Preferred dehydrated vegetable products of the invention are provided with an enlarged size such that the inventive dehydrated vegetable products would not be rehydratable to replace at least 80% of the previously removed moisture in 60 minutes or less, at a temperature of 210° F. or greater.

The invention thus contemplates meal kits for slow cooker applications that include at least a certain amount (weight percent) of dehydrated vegetable products having an enlarged size. For example, the meal kits can include at least 5 wt-%, 10 wt-%, 25 wt-%, or 50 wt-% enlarged dehydrated vegetable products. According to these particular embodiments, the invention provides meal kits for slow cooker applications, the meal kits comprising a dehydrated vegetable product and instructions for preparation of a meal using the dehydrated vegetable product in a slow cooker, wherein at least about 5 wt-%, 10 wt-%, 25 wt-%, or 50 wt-% of the dehydrated vegetable product is provided in a size that is not capable of rehydration to replace at least 80% of previously removed moisture under quick reconstituting conditions, the weight percent of the dehydrated vegetable product based upon total weight of the dehydrated vegetable product. When the meal kit includes an assortment of more than one type of dehydrated vegetable product, at least about 5 wt-%, 10 wt-%, 25 wt-%, or 50 wt-% of the assortment comprises dehydrated vegetable product having a size that is not capable of rehydration to replace at least 80% of previously removed moisture under quick reconstituting conditions.

In still further aspects, the invention provides methods of preparing meal kits for slow cooker applications, as well as methods for preparing a food product comprising rehydrating a dehydrated vegetable product having a moisture content of 12% or less, based upon total weight of the dehydrated vegetable product, for one hour or more, at an average temperature of less than 200° F.

The various aspects of the invention will now be described in more detail.

### DETAILED DESCRIPTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

The present invention is directed to meal kits for slow cooker applications, the meal kits comprising a dehydrated vegetable product and instructions for preparation of a meal using the dehydrated vegetable product in a slow cooker. The invention also provides methods for making such meal kits, as well as methods of rehydrating dehydrated food products for extended times at low temperatures.

Discussion of the inventive meal kits and methods will describe the invention in relation to “slow cooker” applications. Use of this term is meant to encompass slow cooker devices and methods that cook at relatively lower temperatures (as compared to stove-top or oven which use higher cooking temperatures) for relatively long periods of time. The slow cooker can include a crockery pot insert. In some devices, the heating elements can be housed in the sides, so the heat surrounds the food; in other devices, the heating element can be housed in the bottom of the cooker. The slow cooker typically has two heat settings, as described in more detail herein. The terms “slow cooker” “crockery cooker” and “Crock-Pot™” will be used interchangeably herein.

To facilitate the discussion of the invention, use of the invention with dehydrated vegetable products will be addressed. Dehydrated vegetable products are selected because they can be incorporated into meal mixes for slow cooker applications (such as beef stew, pot roast, beef stroganoff, chicken dumpling, pork and rice, and pork and stuffing meals). Further, in terms of providing dehydrated food products that can achieve a desired rehydration profile, the advantages of the invention can be clearly presented. However, it is understood that the compositions and methods disclosed are applicable to any dehydrated food product needs, for example, preparation of dehydrated foods where controlled rehydration of the food product is desired during preparation of the final product.

“Shelf stable” refers to the meal kits of the invention, or individual components thereof, being suitable for storage at ambient temperatures (such as room temperature) without the food composition substantially breaking down by, for example, by microbial contamination, water accumulation, and the like, and becoming unsuitable for consumption.

The meal kits of the invention can include a single type of dehydrated vegetable product, or an assortment of more than one type of dehydrated vegetable products. For example, a meal kit that can be used in a slow cooker to prepare a beef stroganoff meal can include mushrooms as a dehydrated vegetable product; a meal kit that can be used in a slow cooker to prepare pot roast can include dehydrated potatoes, carrots, onions, and celery; while a meal kit that can be used in a slow cooker to prepare a beef stew meal can include dehydrated potatoes, carrots, onions, peas, and corn. The selection of the particular types of dehydrated vegetable products to be included in the meal kit can depend upon the final meal to be prepared, and the combinations of dehydrated vegetable types are practically limitless. Thus, as will be apparent upon review of this disclosure, any vegetables that can be dehydrated as described herein can be provided as a component of the inventive meal kits. Suitable vegetables include, without limitation, asparagus, artichoke, corn, broccoli, cauliflower, cabbage, carrots (including baby carrots), turnips, celery, mushrooms, onions (including pearl onions), leeks, garlic, red and green bell peppers, peas, beans (including green beans), potatoes, squash, tomatoes, water chestnuts, and the like.

The inventive meal kits can further include a seasoning mix, if desired. The seasoning can be chosen depending upon the final meal to be prepared utilizing the meal kit. Exemplary seasonings can include salt, pepper, garlic, onion powder, and the like. In some embodiments, the seasoning kits can include starch, flour, dehydrated sour cream (for example, for preparation of stroganoff meals), dehydrated gravy, dehydrated sauces and toppings, and the like. Seasoning mixes are well known in the art and will not be described further herein.

As used herein, the term “dehydrated” when used to describe a food product, means a food product that has had its moisture content reduced to a level at which microbial growth cannot be supported (typically 8%-18% moisture). Thus, a “dehydrated” food product will typically have a moisture content below 18%, or below 15%, or below 12%, or below 8%. In contrast, intermediate-moisture or semi-moist foods typically contain 15% to 30% moisture.

Dehydrated vegetables can be produced by a variety of processes. These processes differ primarily by the type of drying method used, which depends upon the type of food and the desired characteristics of the final product. In general, dehydrated vegetables undergo the following process steps: pre-drying treatments, such as size selection, peeling, and color preservation; drying or dehydration; post-dehydration treatments; and packaging.

In accordance with some embodiments of the invention, raw vegetable product is subject to pre-dehydrating treatments to prepare the raw product for dehydration. For example, the raw vegetable is selected and sorted according to size, maturity, and soundness. The raw vegetable is then washed to remove unwanted material that might contaminate or affect the color, aroma, or flavor of the vegetable, such as dust, dirt, insect matter, mold spores, plant parts, and the like. If desired, the vegetable can be peeled to remove unwanted parts such as waxy surface coatings. Peeling or removal of any undesirable parts can be accomplished by subjecting the raw vegetable to lye or alkali solution, dry caustic and mild abrasion, steam pressure, high-pressure washers, or flame peelers. Optionally, the product is cut into the desire shape or form (for example, halves, wedges, slices, cubes, nuggets, and the like). Alternatively, vegetables such as corn or onions (such as pearl onions) can be used whole and do not require any cutting or processing to provide a desired shape or size.

In some embodiments, vegetables can be blanched by immersion in hot water (95° to 100° C./203° to 212° F.) or exposure to steam. Generally, blanching involves heating the foodstuff rapidly to a pre-set temperature, holding the temperature for a pre-set time, and then cooling rapidly to near ambient temperatures. One of skill in the art can readily determine blanching time, if any, depending upon such factors as the type of foodstuff, size of the pieces of food, the blanching temperature desired, and the method of heating. In some embodiments of the invention, blanching can soften the texture of the foodstuff to an undesirable extent. To address this texture change, divalent salts, such as calcium chloride (typically 1-2% solution), can be added to blancher water to form insoluble calcium pectate complexes and thus to maintain firmness in the tissues of the foodstuff.

Optionally, the vegetable is subject to color preservation treatment (also referred to as “sulfuring”). For example, vegetables such as potatoes, cabbage, mushrooms, and/or carrots can be treated with sulfite solutions to retard enzymatic browning. In addition to color preservation, the presence of a small amount of sulfite in blanched, cut vegetables can improve storage stability and can allow utilization of increased drying temperatures during dehydration, which in turn can decrease drying time and increase the drier capacity without exceeding the tolerance for heat damage. For example, potatoes can be treated with sodium bisulfite to provide a final sulfite concentration of 200-650 ppm of the potato.

Dehydration is the removal of the majority of water contained in the natural vegetable and is the primary stage in the production of dehydrated vegetables. Preferably, the food product is dehydrated for a time and under conditions sufficient to effect the removal of about 10% to 99% by weight moisture from the food product.

Typical moisture contents based upon total weight of raw vegetables before any dehydration occurs include: carrots, about 90%; sweet potatoes, about 83%; bell peppers, about 81%; Red Pontiac potatoes, about 85%; White Rose potatoes, about 85%. As is generally known, however, the natural moisture contents of all vegetables vary within ranges. The Composition of Foods; Raw, Processed and Prepared, Agricultural Handbook No. 8, Agricultural Research Service, U.S.D.A., U.S. Government Printing Office, Washington, D.C. 20402 sets forth the moisture content ranges for a variety of food materials including those that can be processed in accordance with the present invention.

Several dehydration methods are commercially available, and the selection of the optimal method is determined by quality requirements, raw material characteristics, and economic factors. In some preferred embodiments, atmospheric dehydration is used to remove the majority of water from the vegetable products. Suitable atmospheric dehydration methods include stationary or batch processes (such as kiln, tower, and cabinet driers). In some embodiments, sub atmospheric dehydration can be utilized, for example, vacuum shelf, vacuum belt, vacuum drum, and freeze driers. The particular dehydration method selected is not critical to the inventive products and methods, so long as the desired final moisture content of the vegetable product is achieved.

In preferred embodiments, the vegetable product is dehydrated to provide a final moisture content of 12% or less, 10% or less, or 8% or less. The final moisture content will depend upon the food product; for example, mushrooms can be dehydrated to provide a final moisture content that is greater than that of corn. The following table lists preferred final moisture contents for exemplary food products:

TABLE I
Exemplary final moisture content of selected food products

| Dehydrated | | | | Maximum % |
|---|---|---|---|---|
| Vegetable | Diameter | Thickness | | moisture |
| Mushrooms | 9-14 mm | 1-2 | mm | 8 |
| Carrots | 11-25 mm | 3 | mm | 6 |
| Skin-on Potato Slices | 30% max through a ½ inch U.S. | 6.5 | mm | 8.5 |
| | Standard Sieve; 0.5% max through | | | |
| | a #8 U.S. Standard Sieve | | | |
| Skin-off Potato Slices | 30% max through a ½ inch U.S. | 6.5 | mm | 8.5 |
| | Standard Sieve; 0.5% max through | | | |
| | a #8 U.S. Standard Sieve | | | |

| | Granulation information (U.S. Standard Sieve) | |
|---|---|---|
| Peas | 3% max (through #8 sieve) | 7.5 |
| Corn | | 3.5 |
| Onions 12.7 mm (½ | 1% max (through a U.S. Std. #12) | 5 |
| inch) | 90% minimum (retained on a U.S. Std. #6) | |
| Large chopped onions | 10% max (through #12) | 5 |
| | 2% max (retained on #0.265) | |
| | 30% minimum (retained on a #6) | |
| Celery 3 mm (⅛ | 1% max (through a #⅜ inch) | 5 |
| inch) slice | 25% max (through a #25) | |
| | 5% max (through a #10) | |

Despite conventional teaching to avoid case hardening of dehydrated vegetable products, it has been surprisingly discovered that such case hardening can actually provide beneficial features in slow cooker applications. Thus, according to some embodiments of the invention, the vegetable product can be dehydrated in such a way to achieve case hardening of the individual vegetable food pieces. According to these embodiments, the dehydrated vegetable product can be provided with a closed or hard exterior surface, and a more typical open cell structured interior. Preferably, the exterior surface of the dehydrated vegetable is provided with a sufficient amount of a closed cell structure to retard moisture pick up during cooking (rehydration). This closed cell structure creates a vitreous like material on the exterior surface of the dehydrated vegetable.

The invention will thus be described in relation to a vitreous like material on the surface of the dehydrated vegetable product. As used herein, the vitreous like material is a closed-cell structure that retards penetration of moisture into the dehydrated vegetable product. The vitreous like material thus renders the dehydrated vegetable product resistant to hydration. At the same time, however, the vitreous like material is provided on the surface of the dehydrated vegetable products, and does not significantly permeate the interior of the vegetable product. The result is a vegetable product that, upon rehydration, provides a desirably moist, yet firm vegetable product that closely resembles its fresh food counterpart. In some embodiments, the individual food pieces of a dehydrated vegetable product for slow cooker applications can include vitreous like material on 25% or more of the surface area, or 30% or more, or 50% or more of the surface area of the dehydrated vegetable product.

When the meal kits of the invention include an assortment of more than one type of dehydrated vegetable product, at least one type of dehydrated vegetable product of the assortment can have a vitreous like material on 25% or more of the surface area, or 30% or more, or 50% or more of the surface area of the dehydrated vegetable product. For example, a meal kit containing an assortment of carrots, peas, and potatoes can be provided, wherein the potatoes have a vitreous like material on 25% or more of the surface area of the individual potatoes. In another example, the meal kit containing carrots, peas, and potatoes can be provided, wherein the potatoes and carrots have a vitreous like material content of 25% or more, etc.

It has been surprisingly discovered that utilizing case hardened dehydrated vegetable products in slow cooker applications can provide an improved final cooked food product. According to this aspect of the invention, the vegetable product added to the slow cooker contains some closed, hard exterior surface and a typical open textured interior. It is believed this hard exterior surface can contribute to a slower rehydration of the vegetable product, which in turn can provide a vegetable product that has more stability during the long cooking times applicable to slow cookers. By slowing the rehydration process of the individual vegetable products, the vegetable pieces do not become mushy during the long cooking times.

According to some embodiments of the invention, the meal kits can include a dehydrated vegetable product having a functional (stabilizing) amount of a stabilizer, and instructions for preparation of a meal using the dehydrated vegetable product in a slow cooker. Surprisingly, incorporation of stabilizers that have been conventionally used in applications for hydrated products (such as canned vegetables), can contribute to improved dehydrated vegetable products for slow cooker applications. According to these aspects of the invention, the stabilized dehydrated products can preferably provide a final, rehydrated product that exhibits improved texture qualities.

The dehydrated vegetable product can optionally be subjected to post dehydration treatments as desired. In some preferred embodiments, the dehydrated vegetable product is subjected to a stabilization treatment to enhance the structure of the dehydrated vegetable product and provide desired rehydration characteristics. Post dehydration treatments can provide such advantages as enhancing the crosslinked structure of the starch and/or protein of the vegetable product. In some embodiments, post dehydration treatments can enhance the texture of the vegetable product directly or retard rehydration during cooking.

According to the invention, stabilization treatment can include application of a stabilizer to the dehydrated vegetable product. Suitable stabilizers include hydrocolloids, proteins, texture and consistency control agents (such as emulsifiers, firming agents, starch, and texturizers), and mixtures thereof.

Suitable hydrocolloids include agar, carboxymethyl cellulose, dextrin, carrageenan, gellan, guar, gum Arabic, karaya, locust bean, pectin, xanthan, or others, and mixtures thereof.

Suitable proteins include egg proteins (such as egg albumen), wheat proteins (such as wheat gluten), caseinates, and gelatin.

Suitable texture and consistency control agents include emulsifiers, firming agents, and texturizers. Examples of suitable emulsifiers include mono- and diglycerides of fatty acids and/or the acetylated forms of mono- and diglycerides, such as diacetylglyceride, monopalmitin, monostearin, monoolein, and dipalmitin; partial fatty esters of glycols, such as propylene glycol monostearate; higher fatty acid esters of sugars, such as the partial palmitic and oleic acid esters of sucrose; phosphoric and sulfuric acid esters, such as dodecyl-glyceryl ether sulfate and monostearin phosphate; and phospholipids, such as lecithin; and the like. Other examples include the partial esters of hydroxycarboxylic acids, such as lactic, citric, and tartaric acids with polyhydric compounds, for example, glycerol lacto-palmitate, and the polyoxyethylene esters of fatty esters of polyhydric alcohols, such as polyoxyethylene esters of sorbitan monostearate or distearate. Fatty acids alone or esterified with a hydroxy carboxylic acid, e.g., stearyl-2-lactylate, are also useful.

Suitable firming agents include aluminum sulfates; calcium carbonate; calcium chloride; calcium citrate; calcium gluconate; calcium hydroxide; calcium lactate; calcium phosphate, monobasic; calcium sulfate; magnesium chloride; and the like.

When included, the starch used can be any of the common food starches, for example, potato starch, cornstarch, wheat starch, rice starch, barley starch, oat starch, tapioca starch, arrowroot, and sago starch. Modified starches and pregelantinized starches can also be used.

Suitable texturizers include carrageenan; mannitol; sorbitol; glycerin; glycerol; propylene glycol; pectin; sodium caseinate; sodium citrate; and the like.

Further, the firmness and texture of some vegetables can be manipulated during processing without the use of direct additives. For example, pectin methylesterase can be activated during low temperature blanching (20-82° C. for 3-15 minutes) rather than inactivated as is the case during typical blanching (88-100° C. for 3 minutes). The degree of firmness produced following low-temperature blanching can be controlled by the holding time prior to dehydration. Activation of pectin methylesterase results in hydrolysis of pectin to yield pectinic and pectic acids, which are relatively insoluble and remain in the cell wall during processing to produce firm textures. In some embodiments, addition of calcium ions in conjunction with enzyme activation can lead to additional firming effects.

The stabilizer can be provided to the vegetable product in any desirable manner. For example, in some embodiments, the vegetable product is immersed in a composition that includes the stabilizer. In alternative embodiments, the stabilizer can be applied as a coating to the vegetable product, for example, by spraying or otherwise spreading the stabilizer on the exterior of the vegetable product. Methods of applying stabilizers to food products are known and will not be discussed further herein.

When the meal kits include an assortment of more than one type of dehydrated vegetable product, one or more of the individual types of dehydrated vegetables can include a stabilizer. For example, in a meal kit including dehydrated carrots, peas, and potatoes, the carrots can include a stabilizer. Alternatively, the carrots and peas can include the stabilizer. In still other embodiments, the carrots, peas, and potatoes can each include stabilizer. Moreover, the stabilizer for each individual type of dehydrated vegetable product can be the same or different.

According to the invention, stabilizer is provided to the vegetable products in an amount sufficient to provide a stabilized vegetable product. Stabilized vegetable products can be rehydrated to replace at least 80% of previously removed moisture at an average temperature of less than 200° F. for one hour or more. Alternatively, stabilized vegetable products can be rehydrated to replace at least 85%, or at least 90%, of previously removed moisture at an average temperature of less than 200° F. for 1 hours or more. Upon rehydration, preferred stabilized vegetable products reconstitute to a uniform degree. Preferably, the resultant rehydrated product does not exhibit objectionable interiors (e.g., chewy) or exteriors (e.g., mushy surfaces that tend to slough during reconstitution).

The amount of stabilizer added to a particular vegetable product can be selected depending upon such factors as type of vegetable, size, desired texture of the final, rehydrated product, and the like. One or more stabilizers can be provided for a vegetable product. The total amount of stabilizer added to a particular vegetable product will typically be as little as 0.001 weight percent, or as much as 7 weight percent of the vegetable product.

According to some embodiments of the invention, the invention provides dehydrated food compositions comprising dehydrated vegetable pieces having an enlarged piece size. Instant soup articles conventionally include dehydrated vegetable pieces. Typically, however, in the prior art practice, the dehydrated vegetable pieces have a mean piece size of 1/8 inch. In contrast, the invention provides meal kits comprising enlarged vegetable pieces.

Thus, in some embodiments, the dehydrated food pieces are provided in a size that is not rehydratable to replace at least 80%, or at least 90%, of previously removed moisture under quick reconstituting conditions, the weight percent of the dehydrated vegetable product based upon total weight of the dehydrated vegetable product.

In some preferred embodiments, the dehydrated vegetable pieces have a piece size in the range of 1/8 inch, or 1/4 inch, or ½ inch, or 5/8 inch, or 7/8 inch, or 1½ inch (these dimensions refer to the smallest dimension on a three-dimensional piece, or the diameter of a spherical piece). Exemplary piece sizes for selected dehydrated vegetables are illustrated in Table 1 above.

When the inventive meal kits include an assortment of more than one type of dehydrated vegetable product, one or more of the individual types of dehydrated food products can be provided with an enlarged piece size, as desired.

The invention thus contemplates meal kits for slow cooker applications that include at least a certain amount (weight percent) of dehydrated vegetable products having an enlarged size. For example, the meal kits can include at least 5 wt-%, 10 wt-%, 25 wt-%, or 50 wt-% enlarged dehydrated vegetable products. According to these particular embodiments, the invention provides meal kits for slow cooker applications, the meal kits comprising a dehydrated vegetable product and instructions for preparation of a meal using the dehydrated vegetable product in a slow cooker, wherein at least about 5 wt-%, 10 wt-%, 25 wt-%, or 50 wt-% of the dehydrated vegetable product is provided in a size that is not capable of rehydration to replace at least 80% of previously removed moisture under quick reconstituting conditions, the weight percent of the dehydrated vegetable product based upon total weight of the dehydrated vegetable product. When the meal kit includes an assortment of more than one type of dehydrated vegetable product, at least about 5 wt-%, 10 wt-%, 25 wt-%, or 50 wt-% of the assortment comprises dehydrated vegetable product having a size that is not capable of rehydration to replace at least 80% of previously removed moisture under quick reconstituting conditions.

In some aspects, the inventive meal kits can include dehydrated vegetables having a wide range of sizes and configurations that can be rehydrated in slow cooker applications. According to the invention, the dehydrated vegetables can be provided in any desired configuration. In some embodiments, whole vegetables can be used (for example, in the case of corn, pearl onions, baby carrots, and the like). Optionally, the vegetables can be cut to provide such desirable configurations as wedges, slices (whole, half, random, and the like), cubes, dices, and other such configurations that can be desirable for slow cooker meals. Such configurations can contribute to the “home cooked” impression of slow cooker meals prepared in accordance with the inventive concepts. The particular configuration is not critical to the invention, so long the dehydrated vegetable products are provided in a size and configuration suitable for rehydration in a slow cooker application as described herein.

The dehydrated vegetable product having a storage stable moisture content can then be packaged in a conventional manner for handling and storage purposes. Thus, in some embodiments, the invention provides meal kits including a dehydrated vegetable product as described herein, and packaging for the dehydrated vegetable product. Optionally, the packaging can include instructions for preparation of a meal using the dehydrated vegetable product.

To prepare the dehydrated food products of the invention for consumption, the user places the dehydrated vegetables in hot water in a slow cooker, and the water mixture is then covered and cooked for 4 or more hours or until the food product is suitably tender. Preferably, the dehydrated food products of the invention can be combined with one or more meats, to provide a meat and vegetable dish.

An exemplary embodiment, comprising a shelf stable dehydrated pot roast meal kit will now be described. The meal kit can include dehydrated potatoes, carrots, onions, celery, and gravy mix. The only ingredients required to be supplied by the user are water, a slow cooker, and thawed (or precooked) meat. The gravy mix and dehydrated vegetables are added with hot water and to a slow cooker, and the water mixture is stirred until the gravy mix is dissolved. The meat (such as thawed boneless beef roast) is then added to the slow cooker, and the mixture is covered and cooked on low heat setting for 8 to 10 hours (or high heat setting 4 to 5 hours) or until the meat is tender. The slow cooker is turned off, the meat is optionally removed, and the mixture in the slow cooker is stirred and allowed to stand uncovered for a suitable time to allow the gravy to thicken (for example, about 5 minutes). If desired, and particularly if the meat has been removed from the slow cooker, the meat can then be sliced and served with the vegetables and gravy. Alternatively, of course, the meat can remain in the slow cooker and simply served with the vegetables and other ingredients of the meal.

The vegetable products prepared in this manner are essentially completely reconstituted and have a taste, texture, appearance, and other organoleptic characteristics closely resembling vegetables prepared directly from the fresh state than heretofore has been commercially available.

In addition to the high quality of the food products made in accordance with the present invention, the dehydrated vegetable products of the food products are slow rehydrating. For purposes of the invention, slow rehydrating means reconstitution of the dehydrated product is achieved in 4 hours or more to a moisture content closely approaching the moisture of the raw material form which it was made. Moisture replacement can be expressed in terms of a Moisture Replacement Value (that is, the replacement percentage). Replacement of at least 80%, or at least 85%, or at least 90%, or at least 95% of the moisture is preferably achieved for the product to resemble its fresh food counterpart.

Moisture replacement can also be expressed in terms of the Rehydration Ratio of the product. Generally speaking, the rehydration ratio of a foodstuff is determined by weighing a quantity of dehydrated foodstuff, rehydrating such foodstuff in water, draining the foodstuff of free water, and weighing the rehydrated foodstuff. For the inventive compositions, the Rehydration Ratio of a foodstuff is calculated by rehydrating a dehydrated foodstuff in water having an average temperature in the range of about 120° to 200° F. for a period 4 hours or more. The rehydrated foodstuff is then weighed, and the weight of the foodstuff after rehydration is divided by the weight of the product in its dehydrated stated. Exemplary Rehydration Ratios for dehydrated foodstuffs having the dimensions listed in Table I are given in Table 2 below:

TABLE 2
Rehydration Ratios.

| Vegetable | Rehydration Ratio |
|---|---|
| Mushrooms | 1:5 |
| Carrots | 1:3.5-5.5 |
| Skin-on Potato Slices | 1:3.6 minimum |
| Skin-off Potato Slices | 1:3.6 minimum |
| Peas | 1:5 |
| Corn | 1:4 |
| Onions (½ inch) | 1:8 |
| Large chopped onions | 1:8 |
| Celery ⅛ inch slice | 1:5 |

Upon reconstitution, dehydrated vegetables according to the invention that have been rehydrated in slow cooker applications (for example, a Crock-Pot™) exhibit rehydration ratios that are equal or higher than conventionally dehydrated vegetables. Rehydration ratios for dehydrated vegetables according to the present invention that represent a replacement of at least about 80% of the moisture that had previously been removed during dehydration are listed in Table 2. The dehydrated vegetable pieces were held a slow cooker, with a sauce and seasoning packet and sufficient excess water to allow complete rehydration. This product was considered excellent in taste, texture, and appearance and exhibited no sign of sloughing.

Generally speaking, rehydrating dehydrated vegetables in simple boiling water (that is, water that does not contain additional ingredients and is boiled using a heat source other than a slow-cooker) will provide a faster rehydration rate than rehydrating the dehydrated vegetables in a slow cooker. As a result, the times are typically shorter and the rehydration rate is faster than in a slow cooker. In boiling water, there is no competition for moisture from the starches and other ingredients that would be present in a slow cooker meal kit. In addition, the convective mixing with a few vegetables in boiling water is typically better than the rate of heating achieved in a slow cooker. The rehydration values described in this application were determined by rehydration in a slow cooker, unless noted otherwise.

In still further embodiments, the invention provides methods for preparing meal kits for slow cooker applications. The methods can comprise steps of providing a vegetable, dehydrating the vegetable to provide a dehydrated vegetable product having a vitreous like material content on at least 25% of the surface area of the vegetable piece, and packaging the dehydrated vegetable product for use with a slow cooker application. Preferably, the dehydrated vegetable product is packaged with instructions for preparation of a meal using the dehydrated vegetable product and a slow cooker.

The methods can comprise steps of providing a vegetable, treating the vegetable with a stabilizing amount of a stabilizer to provide a stabilized vegetable product, dehydrating the vegetable, and packaging the stabilized vegetable product. The dehydrating step can be performed before or after the treating step. Further, the stabilizer can be provided in any suitable manner to the vegetable. In some embodiments, for example, the stabilizer can be provided on the surface of the vegetable, while in other embodiments, the vegetable can be infused with the stabilizer.

The invention further provides methods for preparing food products comprising rehydrating a dehydrated vegetable product having a moisture content of 12% or less, or 8% or less, based upon total weight of the dehydrated vegetable product, for four hours or more, at an average temperature of less than 200° F. In some embodiments, an assortment of more than one type of dehydrated vegetable products can be rehydrated according to the inventive methods.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims. All patents, patent documents, and publications cited herein are hereby incorporated by reference as if individually incorporated.

1. A shelf stable meal kit for slow cooker applications, the meal kit comprising:
a. a dehydrated vegetable product having an exterior surface composed of a hardened, closed cell structure; and
b. instructions for preparation of a meal using the dehydrated vegetable product in a slow cooker.

2. A shelf stable meal kit for slow cooker applications, the meal kit comprising:
a. a dehydrated vegetable product having a surface area, wherein at least 25% of the surface area comprises a vitreous like material; and
b. instructions for preparation of a meal using the dehydrated vegetable product in a slow cooker.

3. The meal kit according to claim 2 wherein the meal kit comprises an assortment of more than one type of dehydrated vegetable product, and wherein at least one type of dehydrated vegetable product of the assortment contains vitreous like material on at least 25% of the surface area.

4. The meal kit according to claim 3 wherein at least 5 weight percent of the assortment comprises dehydrated vegetable products having a moisture content of 12 weight percent or less, based upon total weight of the assortment.

5. The meal kit according to claim 3 wherein at least 5 weight percent of the assortment comprises dehydrated vegetable products having a Moisture Replacement Value of 80% or more, based upon total weight of the assortment.

6. The meal kit according to claim 2 further comprising a seasoning composition.

7. The meal kit according to claim 3 further comprising a seasoning composition.

8. The meal kit according to claim 6 wherein the seasoning composition and the dehydrated vegetable product are packaged together.

9. The meal kit according to claim 7 wherein the seasoning composition and the dehydrated vegetable product are packaged together.

10. The meal kit according to claim 8 wherein the moisture content of the dehydrated vegetable product and seasoning composition in the package is 8% or less.

11. The meal kit according to claim 9 wherein the moisture content of the dehydrated vegetable product and seasoning composition in the package is 8% or less.

12. A shelf stable meal kit for slow cooker applications, the meal kit comprising:
a. a dehydrated vegetable product having a stabilizing amount of a stabilizer; and
b. instructions for preparation of a meal using the dehydrated vegetable product in a slow cooker.

13. The meal kit according to claim 12 wherein the meal kit comprises an assortment of more than one type of dehydrated vegetable product, and wherein one or more types of dehydrated vegetable products of the assortment includes a stabilizing amount of a stabilizer.

14. The meal kit according to claim 13 wherein the stabilizer for each type of dehydrated vegetable product is the same.

15. The meal kit according to claim 12 wherein the stabilizer is selected from hydrocolloids, proteins, emulsifiers, firming agents, starch, texturizers, and mixtures thereof.

16. The meal kit according to claim 13 wherein the stabilizer is selected from hydrocolloids, proteins, emulsifiers, firming agents, starch, texturizers, and mixtures thereof.

17. The meal kit according to claim 12 wherein the stabilizer is provided as a coating on the surface of the dehydrated vegetable product.

18. The meal kit according to claim 13 wherein the stabilizer is provided as a coating on the surface of the dehydrated vegetable product.

19. The meal kit according to claim 12 wherein the stabilizer is infused in the dehydrated vegetable product.

20. The meal kit according to claim 13 wherein the stabilizer is infused in the dehydrated vegetable product.

21. A shelf stable meal kit for slow cooker applications, the meal kit comprising:
a. a dehydrated vegetable product; and
b. instructions for preparation of a meal using the dehydrated vegetable product in a slow cooker,
wherein at least about 5 weight percent of the dehydrated vegetable product is provided in a size that is not capable of rehydration to replace at least 80% of previously removed moisture under quick reconstituting conditions, the weight percent of the dehydrated vegetable product based upon total weight of the dehydrated vegetable product.

22. The meal kit according to claim 21 wherein the meal kit comprises an assortment of more than one type of dehydrated vegetable product, and wherein at least about 5 weight percent of the assortment comprises dehydrated vegetable product having a size that is not capable of rehydration to replace at least 80% of previously removed moisture under quick reconstituting conditions, the weight percent based upon total weight of the assortment.

23. A method for preparing a meal kit for slow cooker applications, the method comprising steps of:
a. providing a vegetable;
b. dehydrating the vegetable to provide a dehydrated vegetable product having an exterior surface composed of a hardened, closed cell structure; and
c. packaging the dehydrated vegetable product with instructions for preparation of a meal using a slow cooker.

24. A method for preparing a meal kit for slow cooker applications, the method comprising steps of:
a. providing a vegetable;
b. dehydrating the vegetable to provide a dehydrated vegetable product having a surface area and a vitreous like material on at least 25% of the surface area; and
c. packaging the dehydrated vegetable product with instructions for preparation of a meal using the dehydrated vegetable product and a slow cooker.

25. A method for preparing a shelf stable meal kit for slow cooker applications, the method comprising steps of:
a. providing a vegetable;
b. treating the vegetable with a stabilizing amount of a stabilizer to provide a stabilized vegetable product;
c. dehydrating the vegetable; and
d. packaging the stabilized vegetable product with instructions for preparation of a meal using the stabilized vegetable product and a slow cooker.

26. The method according to claim 25 wherein the dehydrating step is performed after the treating step.

27. The method according to claim 25 wherein the dehydrating step is performed before the treating step.

28. The method according to claim 25 wherein the treating step comprises providing the stabilizer on the surface of the vegetable.

29. The method according to claim 25 wherein the treating step comprises infusing the vegetable with the stabilizer.

30. A method for preparing a food product comprising rehydrating a dehydrated vegetable product having a moisture content of 12% or less, based upon total weight of the dehydrated vegetable product, for four hours or more, at an average temperature of less than 200° F.

31. The method according to claim 30 wherein the dehydrated vegetable product has a moisture content of 8% or less.

32. The method according to claim 30 comprising rehydrating an assortment of more than one type of dehydrated vegetable products, wherein the assortment has a moisture content of 12% or less, based upon total weight of the assortment.
